(19) United States
(12) Patent Application Publication
(10) Pub. No.: US 2012/0163920 A1
(43) Pub. Date: Jun. 28, 2012

(54) SUPPORT ASSEMBLY FOR A DRIVE MECHANISM FOR THE INSTALLATION OF GEOTHERMAL CONDUITS ADJACENT A FOUNDATION WALL INSIDE OR OUTSIDE A BUILDING STRUCTURE

(76) Inventor: Alain Desmeules, Montreal (CA)

(21) Appl. No.: 13/037,396

(22) Filed: Mar. 1, 2011

(30) Foreign Application Priority Data
Dec. 23, 2010 (CA) 2,726,381

(51) Int. Cl. F16L 1/028; F16L 1/06

(52) U.S. Cl. 405/184.4

(57) ABSTRACT

A support assembly for a drive mechanism adapted to drive a force transmitting shaft having a soil penetrating head with a geothermal conduit loop attached thereto into the ground under an existing basement concrete floor of a building structure, through a hole formed in the concrete floor. The support assembly may also be secured to opposed transverse foundation walls adjacent the building structure and outside the structure in a small excavated hole. The support assembly comprises a support platform formed of platform sections having interconnecting flanges for interconnection together. Attachment flanges are also provided at opposed ends of the support platform for detachable securement to a respective one of opposed transverse foundation walls adjacent the concrete floor whereby the support assembly extends diagonally between the opposed transverse walls when mounted internally in a basement of the building structure. When secured to the outside of the opposed transverse foundation walls, one of the beam sections extends outwardly from the opposed transverse foundation walls a predetermined distance to support the drive mechanism spaced from the foundation walls.

### TECHNICAL FIELD

The present invention relates to a support assembly for a drive mechanism for the installation of geothermal conduits adjacent a foundation wall inside or outside a building structure.

### BACKGROUND ART

Reference is made to our co-pending U.S. application Ser. No. 12/320,754, entitled “System and method for geothermal conduit loop in-ground installation and soil penetrating head therefor”, filed Feb. 4, 2009, in which there is disclosed a drive mechanism to drive a force transmitting shaft into the ground to install geothermal conduit loops therein. Geothermal systems are usually installed remote from a building structure by drilling holes into the ground and in which conduits are installed. This usually requires heavy and bulky machinery. It is also difficult to adapt geothermal systems to existing buildings or residential dwellings where land mass around most of these dwellings is very restricted. It is very difficult in such limited space to use heavy machinery to drive pipes into the ground or to drive conduit loops into the ground. When installing a geothermal conduit system into the ground it is often required to bore several holes within the ground and to install several conduit loops and to interconnect them together. This requires extensive excavations or surface area to install a complete system.

The use of thermal energy is becoming more and more important due to the high cost of combustible products or electrical energy. Accordingly, existing building structures with limited land thereabout can only convert to geothermal energy if such energy can be captivated from under the existing foundation of the building or very close thereto. Accordingly, such geothermal conduits need to be driven into the soil from the basement concrete floor of the foundation or in a limited space outside the foundation walls. The use of heavy machinery to drive soil penetrating shafts into the ground is not possible for such restricted spaces. Therefore, the solution is to have a modular system whereby the parts thereof are easily transportable and can be assembled by a small work force such as a two person crew and operated in an existing basement of a building.

### SUMMARY OF INVENTION

It is a feature of the present invention to provide a support assembly for a drive mechanism adapted to drive a force transmitting shaft having a soil penetrating head with a geothermal conduit loop attached thereto into the ground under an existing basement concrete floor of a building structure or closely adjacent transverse foundation walls and which substantially overcomes the above-mentioned disadvantages of the prior art.

Another feature of the present invention is to provide a support assembly for a drive mechanism adapted to drive a force transmitting shaft having a soil penetrating head with a geothermal conduit loop attached thereto into the ground under an existing basement concrete floor by the use of interconnectable support platform sections which are removably attachable to opposed transverse foundation walls of a basement concrete structure.

Another feature of the present invention is to provide a support assembly for a drive mechanism adapted to drive a force transmitting shaft having a soil penetrating head with a geothermal conduit loop attached thereto into the ground and wherein the support assembly has a turret support base capable of orienting the drive mechanism at different angles to install several conduit loops into the ground in an area under the turret support base and wherein the drive mechanism can also be angulated at different angular positions.

Another feature of the present invention is to provide a method of installing a geothermal conduit system interiorly under a basement concrete floor or exteriorly adjacent a concrete foundation.

According to the above features, from broad aspect, the present invention provides a support assembly for a drive mechanism adapted to drive a force transmitting shaft having a soil penetrating head with a geothermal conduit loop attached thereto into the ground under an existing basement concrete floor of a building structure through a hole formed in the concrete floor. The support assembly comprises a support platform formed of platform sections having interconnecting means for interconnection together. Attachment means is provided at opposed ends of at least some of the support platform sections for detachable securement to a respective one of opposed transverse foundation walls adjacent the concrete floor whereby the support assembly extends diagonally between the opposed transverse walls.

According to a still further broad aspect of the present invention, there is provided a support assembly for a drive mechanism adapted to drive a force transmitting shaft having a soil penetrating head with a geothermal conduit loop attached thereto into the ground adjacent foundation walls of a building structure. The support assembly comprises a support platform formed of sections having interconnecting means for interconnection together. Attachment means is secured to at least two of these sections for detachable securement to a respective one of opposed transverse foundation walls of the building structure. One of the sections projects exteriorly of the foundation walls and has a support means for securing the drive mechanism spaced from the foundation walls whereby to drive the force transmitting shaft at different angles into the ground.

According to a still further broad aspect of the present invention, there is provided a method of installing a geothermal conduit system under a basement concrete floor. The method comprises forming a hole in the concrete floor spaced from opposed transverse foundation walls to expose the soil thereunder. A support platform is assembled from platform sections. Opposed ends of the assembled support platform are secured to a respective one of the opposed transverse foundation walls with the support platform extending at least partly over the hole. A drive mechanism is secured to the support platform over the hole. A force transmitting shaft having a soil penetrating head is secured to the drive mechanism. A geothermal flexible conduit loop is secured to the soil penetrating head. The drive mechanism is operated to displace the force transmitting shaft into the ground to bury at least part of the geothermal flexible conduit loop.

### BRIEF DESCRIPTION OF DRAWINGS

A preferred embodiment of the present invention will now be described with reference to the accompanying drawings in which:

FIG. 1 is a schematic view showing a plurality of geothermal conduit loops installed into the ground under an existing foundation of a building structure and interconnected together to form a geothermal conduit system which is secured to a heat exchange device to heat air within the building structure or to cool air within the building structure;

FIG. 2 is a perspective view showing the support assembly in an assembled state and connected across opposed transverse foundation walls of a building structure with a hole having been made in the basement concrete floor and a drive mechanism secured to the support assembly over the hole;

FIG. 3 is an enlarged perspective view showing the construction of the drive mechanism and its securement to a section of the support beam assembly;

FIG. 4 is a side view of the drive mechanism secured to the beam assembly and illustrating the position of the angulated end attachment plate securable to the foundation walls as well as illustrating the adjustable inclination support rod; and

FIG. 5 is a top view of a schematic diagram showing various modifications to the support assembly for supporting a drive mechanism over a hole formed in a basement concrete floor adjacent opposed transverse foundation walls or in a restricted exterior area of the opposed transverse foundation walls.

### DESCRIPTION OF PREFERRED EMBODIMENTS

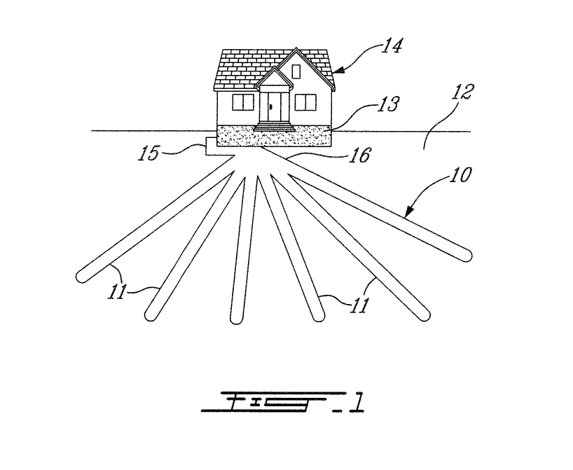

Referring now to the drawings, and more particularly to FIG. 1, there is schematically illustrated a geothermal conduit system consisting of a plurality of geothermal conduit loops 11 installed into the ground 12 under a foundation 13 of a building structure 14, herein a residential building structure. As hereinshown, the conduit loops 11 are interconnected in an upper region above ground in a series configuration whereby a fluid can be circulated through the series assembly of loops from an input end 15 to an output end 16 which are connected to a heat exchange device, not shown herein but obvious to a person skilled in the art, to extract heat from the ground or release heat into the ground to cool the fluid. Reference is herein made to our co-pending application Ser. No. 12/320,754 and entitled “System and method for geothermal conduit loop in-ground installation and soil penetrating head therefor” the contents of which is incorporated herein by reference.

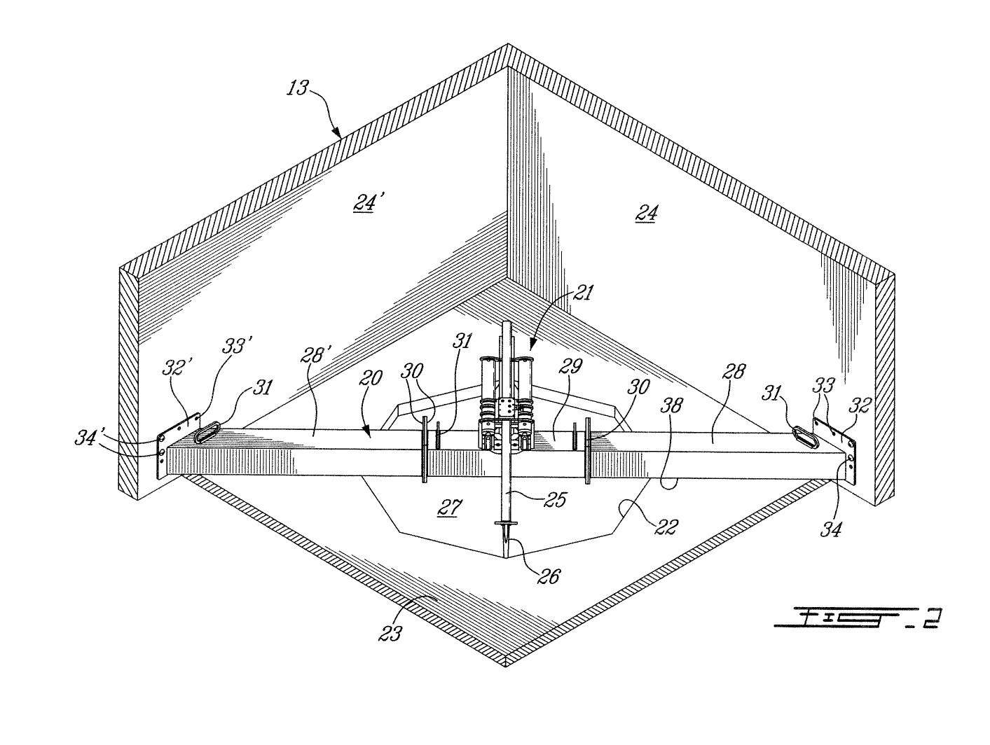

Referring now to FIGS. 2 to 4, there will be described the support assembly 20 of the present invention to support a drive mechanism 21 over a hole 22 formed in an existing basement concrete floor 23 of the building structure as shown in FIG. 1, and adjacent opposed transverse foundation walls 24 and 24′ of the foundation 13. The drive mechanism 21 is adapted to drive a force transmitting shaft having a soil penetrating head 26 into the ground 27. Attached to the soil penetrating head 26 is a conduit loop 11 as shown in FIG. 1. The force transmitting shaft 25 is driven into the ground 27 to a predetermined depth and to do so the force transmitting shaft 25 is formed of short sections which are interconnected end-to-end and easy to transport and assemble in a limited space. FIG. 2 shows the bottom section only of the force transmitting shaft.

Due to the limited space in a basement of an existing building, the support assembly 20 is constructed of support platform sections 28, 28′ and 29. The section 29 is a central platform section to which a drive mechanism is secureable, while the other two sections 28 and 28′ are connected to opposed ends thereof by interconnecting flanges 30. These platform sections facilitate the transport thereof due to their smaller size and the limited space available to transport these into an existing basement. Carrying handles 31 are provided on each of the platform sections 28, 28′ and 30 to facilitate its transport.

As also shown in FIG. 2 attachment means in the form of attachment flanges 32 and 32′ are provided at the free ends of the sections 28 and 28′ and these are provided with holes 33 and 33′ to receive anchor bolts 34 and 34′ to secure the support assembly 20 to the opposed transverse foundation walls 24 and 24′. As can be seen, these attachment flanges 32 and 32′ are angulated at an angle of 45 degrees whereby to support the assembly 20 diagonally between the opposed transverse walls 24 and 24′.

As shown in FIG. 2, there are three platform sections constituted by hollow metal support beams but the assembly could also be constituted by two or more than three of these beam sections whereby to construct a support beam assembly 20 along a straight axis to form an elongated straight support beam. The platform beams are assembled resting on the floor 23.

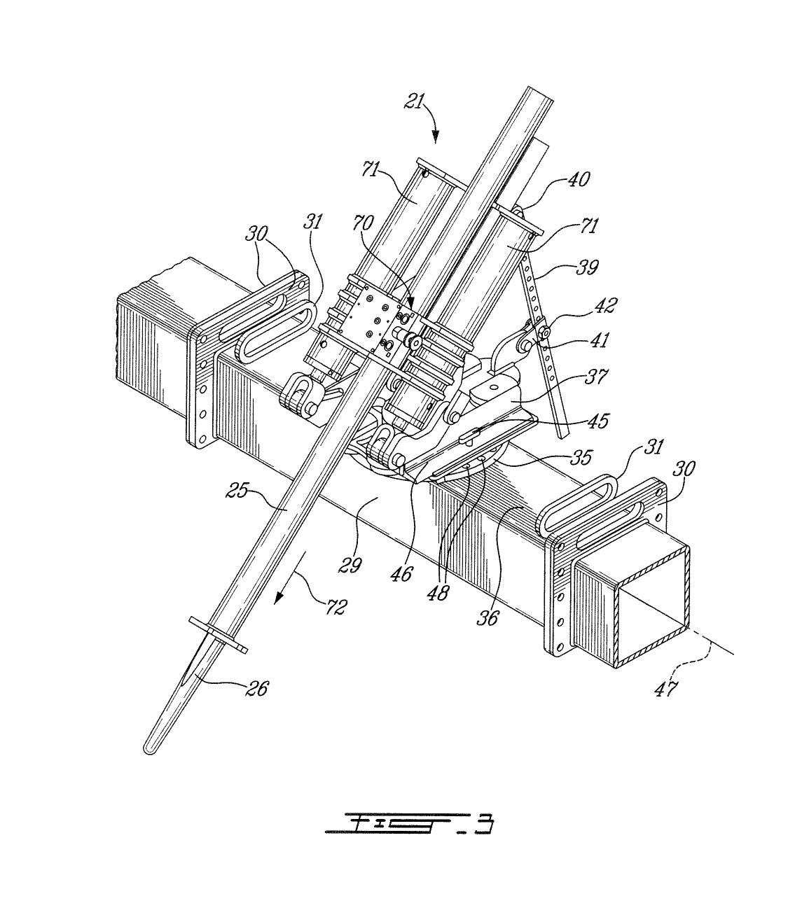

As more clearly illustrated in FIG. 3, a turret support base 35 is secured to the top wall 36 of the central platform section 29 and the drive mechanism is provided with a support base 37 which is detachably secured to the turret support base 35. The connecting mechanism is not shown herein but can consist of several turret attachments obvious to a person skilled in the art. The turret support base makes it possible for the drive mechanism 21 to be oriented at a desired position relative to the support beam and the hole 22 thereunder. To facilitate the assembly of the platform sections 28, 28′ and 29 these are assembled resting on the basement concrete floor 23. As can be seen, the end attachment flanges 32 and 32′ do not extend under the lower surface 38 of the end beams 28 and 28′. Accordingly, it is not necessary to lift the opposed side beam sections 28 and 28′ during assembly and the central platform beam 29 is made smaller, thus lighter, for ease of installation. Of course, the drive mechanism 21 is assembled only after the entire support assembly is connected to the opposed vertical side walls 24 and 24′.

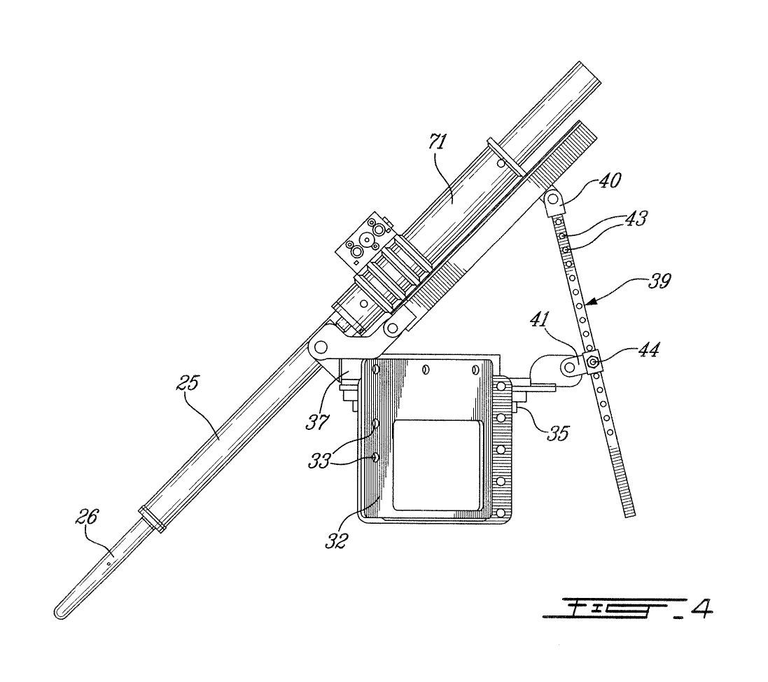

With reference now to FIGS. 3 and 4 it can be seen that the drive mechanism 21 is also provided with an adjustable inclination means, herein constituted by an adjustable support rod 39, pivotally connected at a top end thereof to a pivot connection 40. The adjustable support rod 39 is also guidingly received and displaceable in a pivoting linkage 41 secured to the support base 37. The adjustable support rod 29 is displaced to adjust the angular position of the drive mechanism 21 and therefore the force transmitting shaft 25 with respect to the support beam assembly 20 to drive conduit loops at different angles into the soil 27. Once the angle is selected the support rod is arrested by tightening the bolt 44 to clamp the adjustable support rod 39 to the pivotal linkage 41.

As shown in FIG. 4 the adjustable support rod 39 may also be provided with a plurality of spaced-apart through holes 43 and the means to arrest the support rod with the pivotal linkage 41 may be constituted simply by a bolt fastener positionable through a passage in the pivoting linkage 41 and a selected one of the spaced-apart through holes 43.

As shown in FIG. 3, the support base 37 may also be provided with a locking means in the form of a lock bolt 45 extending through the flange wall 46 of the support base 37 for engagement with the turret support base 35 to maintain the drive mechanism 21 at a desired angle with respect to the longitudinal axis 47 of the support beam assembly. A plurality of pin receiving holes 48 may be disposed about the turret support base 35 to receive the lock bolt 45 in a selected one of these to provide an immovable connection. Of course the lock bolt 45 may be secured to a hinge mechanism secured to the flange 46 to quickly engage and disengage the lock bolt 45 with a selected one of the holes 48 provided in the turret support base 35.

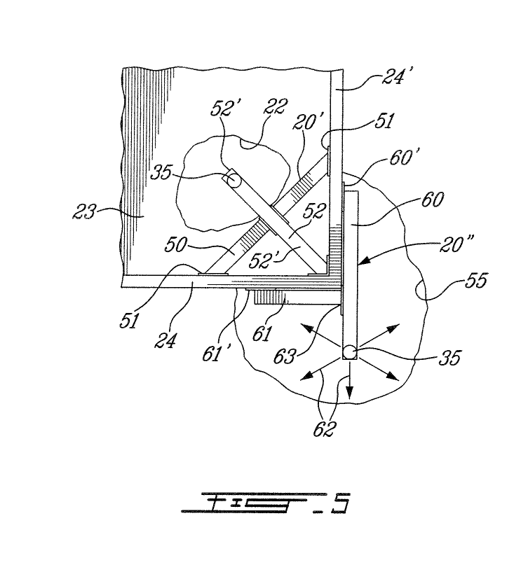

Referring now to FIG. 5, there is shown modifications of the support assembly of the present invention. FIG. 5 illustrates two modifications, one wherein the support assembly 20′ is secured to the opposed transverse foundation walls 24 and 24′ in the basement of an existing building structure but wherein the assembly comprises a diagonal support beam 50 having flanges 51 to secure to the transverse foundation walls and a transverse support beam 52 secured at one end 52′ to a corner of the opposed transverse foundation walls and projecting over the beam 50 and secured thereto and terminating over the hole 22 formed in the basement concrete floor 23. The free end 52′ of the transverse beam 52 is provided with the turret support base 35 for mounting the drive mechanism 21 thereto.

FIG. 5 also shows a further embodiment 20″ of the support beam assembly and herein constituted by two beam sections for securement to the opposed transverse foundation walls 24 and 24′ exteriorly of the building in a hole 55 excavated in the ground adjacent the foundation. This hole can be excavated by a small digging machine, such as a backhoe, which does not require much space to maneuver. As hereinshown, the support assembly 20″ is constituted by an elongated beam section 60 and a shorter transverse beam section 61 each provided with attachment flanges 60′ and 61′, respectively, for securement to the foundation wall. The elongated beam section 60 projects exteriorly of the foundation walls and has the turret support base 35 secured at an extremity thereof whereby to support the drive mechanism 21 thereon. As hereinshown by the arrows 62 the force transmitting shafts can be oriented in a variety of angular positions to secure the conduit loops close to the foundation walls or under the foundation walls. The beam sections 60 and 61 are also interconnected together by an interconnecting flange 63.

In summary, the method of installing the geothermal conduit system under an existing basement concrete floor comprises the steps of firstly forming a hole in the basement concrete floor 23 spaced from opposed transverse foundation walls 24 and 24′ to expose the ground 27 thereunder. The support platform assembly is assembled and secured to opposed transverse foundation walls 24 and 24′, as above-described. The drive mechanism 21 is then secured on the turret support base 35. The force transmitting shafts are then assembled in the force transmitting mechanism 70 which is driven by a pair of pistons 71, as shown in FIG. 3, to reciprocate the drive mechanism 70 to cause the force transmitting shaft 25 to be displaced in the direction of arrow 72 for driving same into the ground. Before doing so a geothermal flexible conduit loop 11 as shown in FIG. 1, is secured to the soil penetrating head 26. The soil penetrating head 26 may have various designs as described in my above-referenced co-pending application. After one loop has been pulled into the ground to a desired depth it is then necessary to reverse the drive mechanism 70 whereby the reciprocation of the pistons 71 will pull the force transmitting shaft 25 in a direction opposed to arrow 72. When the force transmitting shaft 25 is retracted, the soil penetrating head 26 is automatically disconnected from the end of the conduit loop. The drive mechanism is then re-oriented at a different angle with respect to the support beam assembly and may also be angulated at a different angle by means of the adjustable support rod 39. A further conduit loop is secured to the soil penetrating head and the drive mechanism 21 is operated to drive the force transmitting shaft 25 to locate another conduit loop at a different orientation into the soil. Many conduit loops are thus installed into the ground under the foundation at different orientations all through a single hole 22 formed in the basement concrete floor 23 of the building structure. After a predetermined number of these conduit loops have been installed into the ground, the top end portions of the conduit loops which are exposed over the hole 22 are then cut close to the ground and interconnected in series by the use of elbow couplings and tube sections with only an inlet and outlet end of the series connected loops exiting the hole 22. The hole 22 is then filled with concrete and the two exiting end sections are connected to a thermopump-type heat exchange device.

It is within the ambit of the present invention to cover any obvious modifications of the preferred embodiment described herein, provided such modifications fall within the scope of the appended claims.

I claim:

1. A support assembly for a drive mechanism adapted to drive a force transmitting shaft having a soil penetrating head with a geothermal conduit loop attached thereto into the ground under an existing basement concrete floor of a building structure through a hole formed in said concrete floor, said support assembly comprising a support platform formed of platform sections having interconnecting means for interconnection together, attachment means at opposed ends of at least some of said support platform sections for detachable securement to a respective one of opposed transverse foundation walls adjacent said concrete floor whereby said support assembly extends diagonally between said opposed transverse walls.

2. A support assembly as claimed in claim 1 wherein said support platform is constituted by at least two support beams, said interconnecting means interconnecting said at least two support beams along a straight axis to form an elongated straight support beam.

3. A support assembly as claimed in claim 2 wherein said attachment means is constituted by an attachment flange secured at an inclined angle at opposed ends of said elongated straight support beam for abutment and securement with a respective one of said opposed transverse walls.

4. A support assembly as claimed in claim 3 wherein said flanges are provided with through bores for receiving anchor bolts for immovably securing said attachment flanges to said opposed transverse foundation walls.

5. A support assembly as claimed in claim 1 wherein there is further provided a turret support base secured to a top wall of one of said platform sections, said drive mechanism being detachably secured to said turret support base, said turret support base orienting said drive mechanism at a desired position relative to said support beam and said hole.

6. A support assembly as claimed in claim 5 wherein said drive mechanism is connected on a support platform which is pivotally connected to said turret support base, said drive mechanism having a shaft engaging and displacement mechanism for axially displacing said force transmitting shaft to drive and position said geothermal conduit loop into the ground, and adjustable inclination means to angulate said drive mechanism to position said force transmitting shaft at a desired angle.

7. A support assembly as claimed in claim 6 wherein said adjustable inclination means is constituted by an adjustable support rod pivotally connected at a top end to said drive mechanism, said adjustable support rod being guidingly received and displaceable in a pivoting linkage secured to said support base, and means to arrest said support rod at a desired position with respect to said pivoting linkage.

8. A support assembly as claimed in claim 7 wherein said means to arrest said support rod is comprised by a clamp.

9. A support assembly as claimed in claim 7 wherein said support rod is provided with a plurality of spaced-apart through holes, said means to arrest said support rod being comprised by a bolt fastener positionable through a passage in said pivoting linkage and a selected one of said spaced-apart through holes.

10. A support assembly as claimed in claim 5 wherein said support platform is constituted by three support beams, each said support beam having interconnection means for interconnecting said support beams along a straight axis to form an elongated straight support beam, and a turret support base secured to a top wall of a center one of said three support beams, said drive mechanism being detachably secured to said turret support base, said turret support base orienting said drive mechanism at a desired angular position relative to said support beam and said hole in said concrete floor.

11. A support assembly as claimed in claim 2 wherein said support beams are hollow metal support beams, and a carrying handle secured to a top wall of each said at least two hollow metal support beams.

12. A support assembly as claimed in claim 2 wherein said interconnection means is constituted by a transverse connecting flange transversely secured to a transverse end of said support beams for interconnection with one another by the use of fastening means to interconnect said connecting flanges in abutting facial relationship.

13. A support assembly as claimed in claim 6 wherein said support base is provided with locking means for engagement with said turret support base.

14. A support assembly as claimed in claim 13 wherein said locking means is provided by a lock bolt extendable through said support platform for engagement with a selected one of pin receiving holes disposed along a circular axis on a top face of said turret support base.

15. A method of installing a geothermal conduit system under a basement concrete floor comprising the steps of:
i) forming a hole in said concrete floor spaced from opposed transverse foundation walls to expose the ground thereunder;
ii) assembling on said concrete floor a support platform from platform sections;
iii) securing opposed ends of said assembled support platform to a respective one of said opposed transverse foundation walls with said support platform extending at least partly over said hole;
iv) securing a drive mechanism to said support platform over said hole;
v) securing a force transmitting shaft having a soil penetrating head to said drive mechanism;
vi) securing a geothermal flexible conduit loop to said soil penetrating head, and
vii) operating said drive mechanism to displace said force transmitting shaft into the ground to bury at least part of said geothermal flexible conduit loop into the ground.

16. A method as claimed in claim 15 wherein said step (vi) comprises securing a loop end of an elongated U-shaped conduit loop to said soil penetrating head.

17. A method as claimed in claim 15 wherein said step (iv) comprises securing said drive mechanism on a turret support base and orienting said drive mechanism at a desired angle with respect to said support platform.

18. A method as claimed in claim 17 wherein there is also provided before step (v) the step of angulating said drive mechanism at a desired angle with respect to said basement concrete floor.

19. A method as claimed in claim 15 wherein said force-transmitting shaft is comprised by a plurality of shaft sections interconnectable end-to-end with each other, said step (v) comprising securing a first of said shaft sections having said soil penetrating head to said drive mechanism, said step (vii) comprising the steps of driving said first shaft section partly into the soil to permit a second shaft section to be connected to a top end of said first shaft section and operating said drive mechanism to continue to drive said first and second shaft sections into the ground and continuing to add shaft sections until said penetrating head has reached a desired depth into said ground.

20. A method as claimed in claim 19 wherein after said desired depth is reached there is provided the step of withdrawing said interconnected shaft sections from the ground by operating said drive mechanism to operate a shaft engaging mechanism in a shaft withdrawing mode with said geothermal flexible conduit remaining in said ground, and disconnecting said shaft sections as they are withdrawn from the ground.

21. A method as claimed in claim 19 wherein there is further provided the steps of burring several of said conduit loops at different angles into said soil, interconnecting in series top ends of said conduit loops together to circulate a liquid thereto for heat exchange of said liquid with the ground to capture heat from said ground or release heat in the ground.

22. A support assembly for a drive mechanism adapted to drive a force transmitting shaft having a soil penetrating head with a geothermal conduit loop attached thereto into the ground adjacent opposed transverse foundation walls of a building structure, said support assembly comprising a support platform formed of platform sections having interconnecting means for interconnection together, attachment means secured to at least two of said sections for detachable securement to a respective one of said opposed transverse foundation walls of said building structure, one of said sections projecting exteriorly of said foundation walls and having a support means for securing said drive mechanism spaced from said foundation walls whereby to drive said force transmitting shaft at different angles into the ground.

23. A support assembly as claimed in claim 1 wherein said sections are at least two support beam sections, said interconnecting means interconnecting said support beam sections transversely to one another to form two right angle foundation attachment beam sections with one of said beam sections projecting exteriorly of said foundation walls.

24. A support assembly as claimed in claim 23 wherein said attachment means is constituted by an attachment flange secured to each said two right angle foundation attachment beam sections for abutment and securement with a respective one of said opposed transverse foundation walls.

25. A support assembly as claimed in claim 24 wherein said flanges are provided with through bores for receiving anchor bolts for immovably securing said attachment flanges to said opposed transverse foundation walls.

26. A support assembly as claimed in claim 22 wherein there is further provided a turret support base secured to a top wall of one of said platform sections, said drive mechanism being detachably secured to said turret support base, said turret support base orienting said drive mechanism at a desired position relative to said support beam.

27. A support assembly as claimed in claim 26 wherein said support means is a support platform which is pivotally connected to said turret support base, said drive mechanism being connected on a support platform which is pivotally connected to said turret support base, said drive mechanism having a shaft engaging and displacement mechanism for axially displacing said force transmitting shaft to drive and position said geothermal conduit loop into the ground, and adjustable inclination means to angulate said drive mechanism to position said force transmitting shaft at a desired angle.

28. A support assembly as claimed in claim 27 wherein said adjustable inclination means is constituted by an adjustable support rod pivotally connected at a top end to said drive mechanism, said adjustable support rod being guidingly received and displaceable in a pivoting linkage secured to said support base, and means to arrest said support rod at a desired position with respect to said pivoting linkage.

29. A support assembly as claimed in claim 22 wherein said interconnection means is constituted by a transverse connecting flange transversely secured to a transverse end of said support beams for interconnection with one another by the use of fastening means to interconnect said connecting flanges in abutting facial relationship.
